(19) United States
(12) Patent Application Publication
(10) Pub. No.: US 2025/0304246 A1
(43) Pub. Date: Oct. 2, 2025

(54) AIRCRAFT WHEEL OF ONE-PIECE STRUCTURE

(71) Applicant: SAFRAN LANDING SYSTEMS, Velizy Villacoublay (FR)

(72) Inventors: Loïc MERMET-GUYENET, MOISSY-CRAMAYEL (FR); Robin LANDOT, MOISSY-CRAMAYEL (FR); Thierry BERENGER, MOISSY-CRAMAYEL (FR); Xavier MARTIN, MOISSY-CRAMAYEL (FR)

(73) Assignee: SAFRAN LANDING SYSTEMS, Velizy Villacoublay (FR)

(21) Appl. No.: 18/864,317

(22) PCT Filed: May 10, 2023
(86) PCT No.: PCT/EP2023/062515

§ 371 Date: Nov. 8, 2024

(30) Foreign Application Priority Data
May 12, 2022 (FR) FR2204537

(51) Int. Cl. B64C 25/36

(52) U.S. Cl. CPC B64C 25/36

(57) ABSTRACT

A wheel for an aircraft including a first annular half-rim, a first hub coaxial with the first half-rim, and a first disc connecting the first hub to the first half-rim, the first half-rim including a first radially outwardly projecting collar for interacting with a tire. The wheel includes a sleeve formed as a single piece with the first half-rim, the first disc and the first hub to form a first one-piece first half-wheel, and the sleeve extends coaxially with the first half-rim, has an outer surface extending at a distance from an inner surface of the first half-rim, has an end projecting axially from the first half-rim on the opposite side to the first disc, and is provided internally with internal ribs intended for rotatably connecting the wheel to at least one brake rotor disc housed between the sleeve and the first hub.

The present invention relates to the field of aviation and more particularly to aircraft landing gears.

### BACKGROUND OF THE INVENTION

Aircraft landing gears generally comprise a strut having a first end for being hinged to a structure of the aircraft and a second end provided with an axle on which at least one wheel is pivotally mounted.

Aircraft wheels conventionally comprise two half-wheels, each comprising an annular half-rim, a hub coaxial with the half-rim and a disc connecting the hub to the half-rim. Bolts that rigidly interconnect the half-rims pass through the discs. Each of the half-rims comprises a radially outwardly projecting collar for interacting with a tyre received between the two collars. Half-wheels are generally manufactured by stamping and machining.

The space defined by one of the half-rims and the opposite hub receives a stack of brake discs that comprises rotor discs rotatably connected to the half-rim and stator discs rotatably coupled to a torque tube that surrounds the hub and is supported by the strut.

During braking, the brake discs rub against each other, giving off heat. To prevent this release of heat from degrading the tyre, heat shields are fitted between the discs and the inner surface of the half-rim. The heat shields are fastened by screws or comprise resilient parts that interact with shims mounted between the rotor discs and the half-rim.

Furthermore, it is possible that the brake catches fire, and it is important to prevent or at least delay the flames reaching the tyre. For this purpose, a flame-retardant ring (commonly referred to as a “chin ring”) is provided, which is fitted on the half-rim in which the stack of discs extends. The flame-retardant ring projects axially from an outer edge of the half-rim on the opposite side to the disc. The flame-retardant ring is fastened to the outer edge of the half-rim by screws passing radially through said outer edge of the half-rim.

Manufacturing an aircraft wheel of this kind therefore requires complex machining as well as operations for mounting the heat shields and the flame-retardant ring.

### OBJECT OF THE INVENTION

The object of the invention is in particular to provide an aircraft wheel having a different structure from the known structures.

### SUMMARY OF THE INVENTION

To this end, according to the invention, an aircraft wheel is provided, comprising a first annular half-rim, a first hub coaxial with the first half-rim and a first disc connecting the first hub to the first half-rim. The first half-rim comprises a first radially outwardly projecting collar for interacting with a tyre. The wheel comprises a sleeve formed in one piece with the first half-rim, the first disc and the first hub to form a first one-piece half-wheel. The sleeve: extends coaxially with the first half-rim; has an outer surface extending at a distance from an inner surface of the first half-rim; has a first end projecting axially from the first half-rim on the opposite side to the first disc; and is provided internally with internal ribs intended for rotatably connecting the wheel to brake rotors housed between the sleeve and the first hub.

Thus, the sleeve, which is formed as a single piece with the half-rim, the disc and the hub, acts as both a heat shield and a flame-retardant ring. This arrangement reduces the assembly operations and can be carried out in a simple manner by additive manufacturing, preferably powder bed additive manufacturing, for example titanium-based.

According to a particular embodiment, external ribs connect the outer surface of the sleeve to the inner surface of the first half-rim.

The half-rim, the external ribs and the sleeve form an internally partitioned wall. Thus, the external ribs and the sleeve serve to enhance the stiffness of the half-rim, and the external ribs and the half-rim serve to strengthen the sleeve. It is therefore possible to have a relatively small thickness for both the half-rim and the sleeve compared with a conventional wheel structure. Therefore, the mass of a partitioned wall of this kind is less than that of a thick wall made of the same material, for the same strength.

The invention also relates to a landing gear equipped with a wheel of this kind, and to an aircraft comprising a landing gear of this kind.

Other features and advantages of the invention will become clear on reading the following description of a particular and non-limiting embodiment of the invention.

### BRIEF DESCRIPTION OF THE DRAWINGS

Reference is made to the accompanying drawings, among which:

FIG. 1 is a partial schematic view of an aircraft according to the invention, more particularly of a landing gear thereof;

FIG. 2 is a half-view in axial section of a free end of said landing gear;

FIG. 3 is a perspective view of a wheel according to the invention.

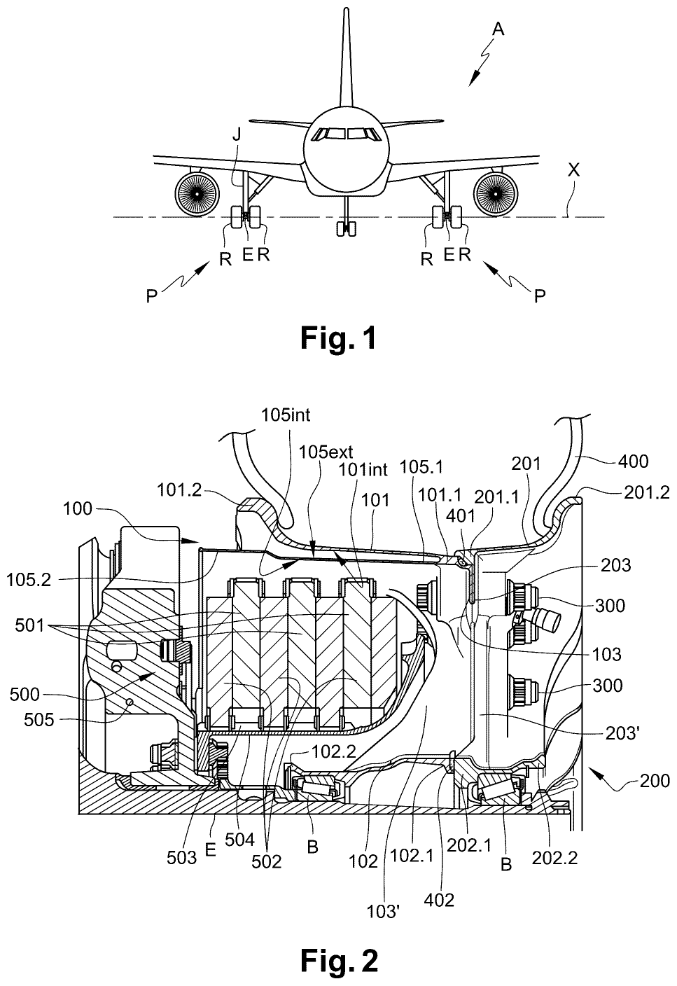

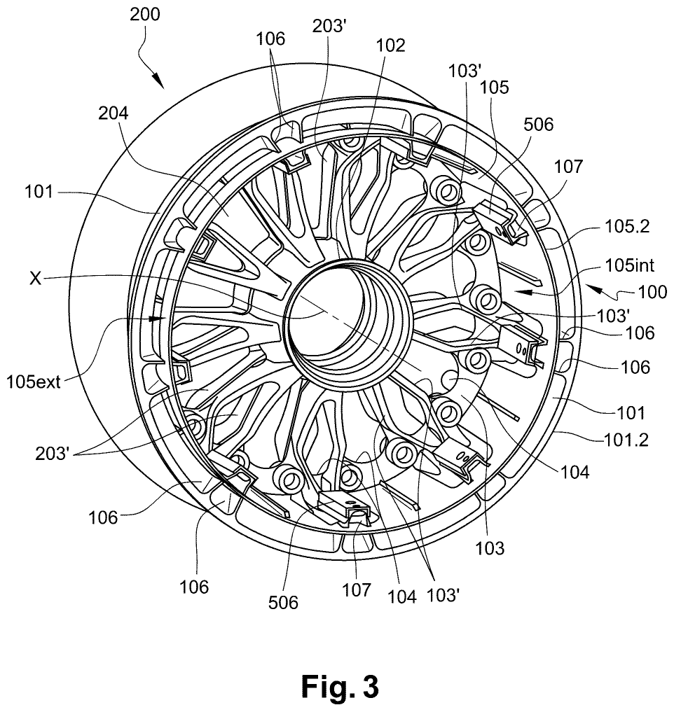

### DETAILED DESCRIPTION OF THE INVENTION

With reference to the drawings, the invention applies to an aircraft A comprising main landing gears P, each comprising a strut J having a first end hinged to a structure of the aircraft A and a second end bearing two wheels R received on an axle E so as to be pivotable about an axis X by means of tapered roller bearings B.

In accordance with FIG. 2, each wheel R comprises two half-wheels 100, 200 that are joined together by bolts 300 and hold a tyre 400 between them.

The half-wheels 100, 200 comprise a half-rim 101, 201, a hub 102, 202 coaxial with the half-rim 101, 201 and a disc 103, 203 connecting the hub 102, 202 to the half-rim 101, 201.

The half-rims 101, 201 are annular in shape and comprise a first annular edge 101.1, 201.1 and a second annular edge 101.2, 201.2. The hubs 102, 202 are tubular in shape and comprise a first end 102.1, 202.1, which is connected to the first annular edge 101.1, 201.1 by the disc 103, 203, and a second, free end 102.2, 202.2. The first annular edges 101.1, 201.1 are pressed against each other by the bolts 300, which are inserted into a thickened peripheral portion of the discs 103, 203 that adjoins the first annular edges 101.1, 201.1. The second annular edge 101.2, 201.2 of the half-rim 101, 201 is a free edge raised to form a collar projecting radially outwards with respect to the rest of the half-rim 101, 201. The tyre 400 is mounted on the half-rims 101, 201 between the second annular edges 101.2, 201.2, which are in sealed contact with the tyre 400 and prevent the tyre 400 from disengaging from the rim formed by the half-rims 101, 201. A seal 401 is pressed between the first annular edges 101.1, 201.1 of the half-rims 101, 201 so that the half-rims 101, 201 and the tyre 400 define a sealed volume capable of receiving a pressurised gas that inflates the tyre 400. In this case, there extends through the second half-rim 201 a channel having one end provided with an inflation valve extending between two bolts 300. A seal 402 is also pressed between the two first ends 102.1, 202.1 of the hubs 102, 202 to prevent dirt from entering between the bearings B.

The disc 103 comprises radial arms 103′, between which there are openings 104 arranged opposite openings 204 between radial arms 203′ of the disc 203. The arms 103′, 203′ have an oblong (in this case rectangular) cross section having a major axis substantially parallel to the central axis of the hubs 102, 202 (i.e. the oblong cross section has its largest dimension along the central axis of the hubs 102, 202). The cross section of the ends of the arms 103′, 203′ (in contact with the hubs 102, 202 and the half-rims 101, 201) is greater than the cross section of the arms 103′, 203′ in their central part, so as to enhance the rigidity of the half-rims 100, 200. In particular, the largest dimension of the cross section of the arms 103′, 203′ at their ends is greater than the largest dimension of the cross section of the arms 103′, 203′ at their central part.

The half-wheel 100 comprises a sleeve 105 extending coaxially with the first half-rim 101 from the first end 101.1 of the first half-rim 101. More precisely, the sleeve 105 has a first end 105.1 rigidly connected to the first end 101.1 of the first half-rim 101, and a second end 105.2 projecting axially from the second end 101.2 of the first half-rim 101 on the opposite side to the disc 103. In this example, the second end 105.2 comprises an end edge formed by a rounded bead. The sleeve 105 is stepped and comprises a first segment in the vicinity of the first end 105.1 and a second segment that extends in the vicinity of the second end 105.2 and is coupled to the first segment by a frustoconical intermediate segment; the first segment has an internal diameter that is less than an internal diameter of the second segment and an external diameter that is less than an external diameter of the second segment.

The sleeve 105 has an outer surface 105ext extending at a distance from an inner surface 101int of the first half-rim 101; the outer surface 105ext is provided with pairs of external ribs 106 which extend axially along the sleeve 105 and connect the outer surface 105ext of the sleeve 105 to the inner surface 101int of the first half-rim 101. The pairs of external ribs 106 are arranged symmetrically with respect to the central axis of the hub 102.

The sleeve 105 has an inner surface 105int provided, at the first segment, with internal ribs 107 extending axially along the sleeve 105. The internal ribs 107 are arranged symmetrically with respect to the central axis of the hub 102. Each internal rib 107 has a C-shaped cross section that has a central web having longitudinal edges from which there extend flanges having a longitudinal edge rigidly connected to the inner surface 105int. Each of the internal ribs 107 extends opposite one of the external ribs 106.

The sleeve 105 and the ribs 106, 106 are formed as a single piece with the first half-rim 101, the first disc 103 and the hub 102 such that the first half-wheel 100 is one piece. The half-wheel 200 is also a one-piece structure, with the half-rim 201, the hub 202 and the disc 203 being a single piece.

In this case, the two half-wheels 100, 200 are manufactured by a powder bed additive manufacturing process using a titanium-based powder. This manufacturing process is known per se and is not described in greater detail herein. Additive manufacturing allows the thicknesses to be limited to what is strictly necessary (without using machining) to ensure the required mechanical performance in particular for the half-rims 101, 201, the hubs 102, 202, the discs 103, 203 and the sleeve 104.

The wheel R comprises a brake device 500 comprising a stack of discs, which comprises rotor discs 501 having peripheral notches engaged on the internal ribs 107 of the sleeve 105 to rotatably connect the wheel R to the rotor discs 501, and stator discs 502 having peripheral notches engaged on external ribs 503 of a torque tube 504 surrounding the axle E and the hub 102. The torque tube 504 has one end rigidly connected to an actuator-carrier ring 505, which is known per se, rigidly connected to the axle E such that the external ribs 503 of the torque tube 504 rotatably connect the stator discs 502 to the axle E. It is noted that the torque tube 504 has an end opposite the actuator-carrier ring 505 which is raised in order to partially envelop the last disc of the stack of discs and protect the discs 103, 203 from heat. In this case, each of the internal ribs 107 is covered by a cover 506 that serves both as a heat shield to limit heat being conducted from the rotor discs 501 to the sleeve 105, and as a sliding surface for the rotor discs 501 in order to limit the rubbing wear on the internal ribs 107.

The actuator-carrier ring 505 of the braking device is provided with actuators for exerting a pressure force on the stack of discs and braking the wheel R.

It is noted that the aligned openings 104, 204 allow at least some of the heat produced during braking to be carried away.

It goes without saying that the invention is not limited to the described embodiment but covers any variant falling under the scope of the invention as defined by the claims.

In particular, the wheel may have a different structure from that described.

For example, the half-wheels may be interconnected by means other than bolts, or they may be a single piece.

The cross-sectional shape of the arms 103′, 203′ of each disc 103, 203 may be different from that described, for example an elliptical cross section.

The first end 105.1 of the sleeve 105 may be spaced apart from the disc 102, the sleeve 105 being connected to the rest of the half-wheel 100 only by the external ribs 106.

Instead of each pair of adjacent external ribs 106, there may be a single, thicker external rib, although the weight of the half-wheel is then increased.

Instead of hollow internal ribs 107, it is possible to have solid internal ribs, although the weight of the half-wheel is then increased.

The internal ribs 107 may be angularly offset from the external ribs 106.

Each half-wheel may be made of a material other than titanium, e.g. aluminium, and manufactured by a manufacturing process other than powder bed additive manufacturing, e.g. by welding and machining.

Each disc may have a more traditional structure in the form of a thin discoid or frustoconical wall.

The torque tube can be connected to the strut or directly to the axle.

Although the invention has been described in relation to a wheel provided with a friction braking device, the invention likewise applies to wheels provided with a magnetic braking device or the like.

1. A wheel for an aircraft, the wheel comprising:
a first annular half-rim,
a first hub coaxial with the first half-rim, and
a first disc connecting the first hub to the first half-rim, the first half-rim comprising a first radially outwardly projecting collar for interacting with a tire,
wherein the wheel comprises a sleeve formed as a single piece with the first half-rim, the first disc and the first hub to form a first one-piece first half-wheel, and
the sleeve:
extends coaxially with the first half-rim;
has an outer surface extending at a distance from an inner surface of the first half-rim;
has an end projecting axially from the first half-rim on the opposite side to the first disc; and
is provided internally with internal ribs intended for rotatably connecting the wheel to at least one brake rotor disc housed between the sleeve and the first hub.

2. The wheel according to claim 1, wherein the internal ribs are formed as a single piece with the sleeve.

3. The wheel according to claim 2, wherein the internal ribs have a C-shaped cross section that has a web having longitudinal edges from which extend flanges having longitudinal edges coupled to an inner surface of the sleeve.

4. The wheel according to claim 1, wherein external ribs connect the outer surface of the sleeve to the inner surface of the first half-rim.

5. The wheel according to claim 1, wherein the first disc comprises arms that define openings between the arms.

6. The wheel according to claim 5, wherein the arms have an oblong cross section having a major axis substantially parallel to the central axis of the first hub.

7. The wheel according to claim 1, comprising a second one-piece half-wheel comprising, as a single piece, a second annular half-rim, a second hub coaxial with the second half-rim and a second disc connecting the second hub to the second half-rim,
wherein the second half-rim comprises a second radially outwardly projecting collar for interacting with the tire received between the first collar and the second collar.

8. The wheel according to claim 7, wherein the discs comprise arms that define aligned openings between the arms, the arms having an oblong cross section having a major axis substantially parallel to the central axis of the hubs.

9. The wheel according to claim 1, comprising a braking device that comprises a stack of discs housed between the sleeve and a torque tube that extends around the first hub,
wherein the stack of discs comprise rotor discs provided with peripheral notches engaged on the internal ribs of the sleeve, and stator discs rotatably connected to the torque tube.

10. A landing gear comprising:
a strut having a first end for being hinged to an aircraft structure and a second end provided with an axle on which at least one of the wheel according to claim 1 is pivotally mounted, the torque tube being fixed in place relative to the strut.
